(19) United States
(12) Patent Application Publication
(10) Pub. No.: US 2005/0162022 A1
(43) Pub. Date: Jul. 28, 2005

(54) Capacitor dropping power supply with shunt switching

(75) Inventor: John Joseph Allard, Amana, IA (US)

Correspondence Address: Kirk W. Goodwin, Esq.;Maytag Corporation, 403 West 4th Street, North, Newton, IA, 50208, US

(73) Assignee: Maytag Corporation, Newton, IA (US)

(21) Appl. No.: 11/035,840

(22) Filed: Jan. 14, 2005

Related U.S. Application Data
(60) Provisional application No. 60/536,714, filed on Jan. 16, 2004.

(51) Int. Cl. H02M 5/42

(52) U.S. Cl. 307/140

(57) ABSTRACT

A capacitor dropping power supply is disclosed wherein diode power dissipation is avoided due to the unique combination of the diode with the capacitive dropping power supply coupled with a silicon control rectifier (“SCR”). Thus, internal power dissipation is minimized when power is not needed by the load by shorting out the diode. This is accomplished in the form of a voltage regulator wherein a zener diode is used to turn on the SCR when the output voltage exceeds a predetermined level. The SCR provides a shunt switching operation, shunting input current and providing a sufficient amount of power to supply the load and shorting out voltages above a set amount. As a result, there is a power savings when power is not being supplied to the load.

This application claims the benefit of U.S. Provisional Application Ser. No. 60/536,714 filed Jan. 16, 2004, which application is hereby incorporated by reference.

### BACKGROUND

1. Field of the Invention

The present invention relates to capacitor dropping power supplies; and more specifically, the invention relates to the use of a silicon control rectifier (“SCR”) to remove wasted wattage from the zener diode regulator to create a savings in power dissipation in refrigeration power supplies.

2. Description of Related Art

Capacitor dropping power supplies are commonly used in appliances that require DC voltage. In the context of refrigeration devices, efficient capacitor dropping power supplies aid in the overall efficiency of the appliance. Currently, in prior art systems, wattage that is pumped into the DC portions of capacitor dropping power supplies is dissipated through a zener diode when the load is turned off. As a result, the heat produced by the wattage that is pumped into the power supply and dissipated by the diode must also be removed from the power supply. There are two problems associated with prior art systems. First, the wattage consumed by the zener diode is wasted and performs no useful work. Second, the wattage must be dealt with on the circuit board and in any enclosure used. In the case of the control being mounted inside a refrigerator, this heat resulting from this wattage dissipation must also be removed by the refrigeration system in order to maintain temperature.

Attempts have been made to increase savings in power dissipation, but all such attempts have fallen short of the advantages disclosed by the present invention. For example, U.S. Pat. No. 6,104,325 to Pecore (“Pecore”) provides such a method, but requires a microcontroller or other smart controller to know if the load is going to be on or off. Therefore, there remains a need in the art to create more efficient capacitor dropping power supplies that save power. The invention disclosed herein overcomes the shortcomings associated with the prior art by using an entirely different and much simpler approach that is essentially a switching regulator.

### SUMMARY OF THE INVENTION

In one embodiment, the invention is a capacitor dropping power supply comprising a first portion that creates a negative DC voltage relative to an AC source. The capacitor dropping power supply also includes a second portion that creates a positive DC voltage relative to the AC source, wherein the second portion comprises a silicon control rectifier (“SCR”) that is used by the capacitor dropping power supply to shunt current from a load in a manner to minimize internal power dissipation thereby increasing operational efficiency. The SCR is controlled to turn on when the output DC voltage exceeds a control voltage of a zener diode, and operates as a shunt switch with minimal power dissipation in the on state by shunting input current and providing just sufficient power to supply the load. This is performed by shorting out voltages above the control voltage.

In another embodiment, the invention is a capacitor dropping power supply comprising a first portion that creates a positive DC voltage relative to an AC source. The capacitor dropping power supply also includes a second portion that creates a negative DC voltage relative to the AC source, wherein the second portion comprises a SCR that is used by the capacitor dropping power supply to shunt current from a load in a manner to minimize internal power dissipation thereby increasing operational efficiency. The SCR is controlled to turn on when the output DC voltage exceeds a control voltage of a zener diode, and operates as a shunt switch with minimal power dissipation in the on state by shunting input current and providing just sufficient power to supply the load. This is performed by shorting out voltages above the control voltage.

In yet another embodiment, the invention is a SCR in a capacitor dropping power supply that is connected in parallel to a load and shunts current when the load is turned off, wherein the current is normally used to supply power when the load is on. The shunting operation of the SCR minimizes internal power dissipation and increases operational efficiency of the capacitor dropping supply. The SCR receives a control input from a zener diode connected in parallel with the load that turns the SCR to the on state. The zener diode sends the control input when an output DC voltage exceeds a control voltage of the zener diode. The SCR shorts out voltages above the control voltage and provides just sufficient power to supply the load.

Other systems, methods, features, and advantages of the present invention will be apparent to one with skill in the art upon examination of the following drawings and detailed description.

### BRIEF DESCRIPTION OF THE DRAWINGS

Many aspects of the invention can be better understood with reference to the drawings. It should be recognized that components in the drawings are not necessarily to scale, emphasis instead being placed upon clearly illustrating the principles of the present invention. It should also be recognized that like reference numerals in the drawings designate corresponding parts from several views. In this light, the following drawings are provided:

FIG. 1 depicts a prior art capacitor dropping power supply;

FIG. 2 depicts one embodiment of a capacitor dropping power supply utilizing the present invention;

FIG. 3 depicts another embodiment of a capacitor dropping power supply utilizing the present invention; and

FIG. 4 depicts a refrigeration device that may use a capacitor dropping power supply utilizing the present invention;

### DETAILED DESCRIPTION OF PREFERRED EMBODIMENTS

The present invention is a capacitor dropping power supply wherein power dissipation in a zener diode when the load is disconnected is avoided through the use of a unique combination of the diode with the capacitive dropping power supply coupled with a silicon control rectifier (“SCR”). The present invention serves to minimize internal power dissipation when power is not needed by the load by shorting out the zener diode. This is accomplished in the form of a voltage regulator wherein the zener diode is used to turn on a silicon controlled rectifier when the output voltage exceeds a predetermined level. Basically, the voltage across the power supply capacitor is checked every ½ cycle, and, if the voltage is too high, it switches the SCR to the “on” state. The SCR provides a shunt switching operation, shunting input current and providing just sufficient power to supply the load and shorting out voltages above a set amount Due to this, there is a power savings when power is not being supplied to the load. In the context of refrigeration devices, the power supply is often internal to the refrigerator compartment. Any power dissipated internal to the refrigeration compartment gives rise to heat that must be removed. Removing the heat caused by the power dissipation in-turn consumes more energy. Avoiding the internal dissipation in the first instance saves the energy that would otherwise be required to remove the resultant heat.

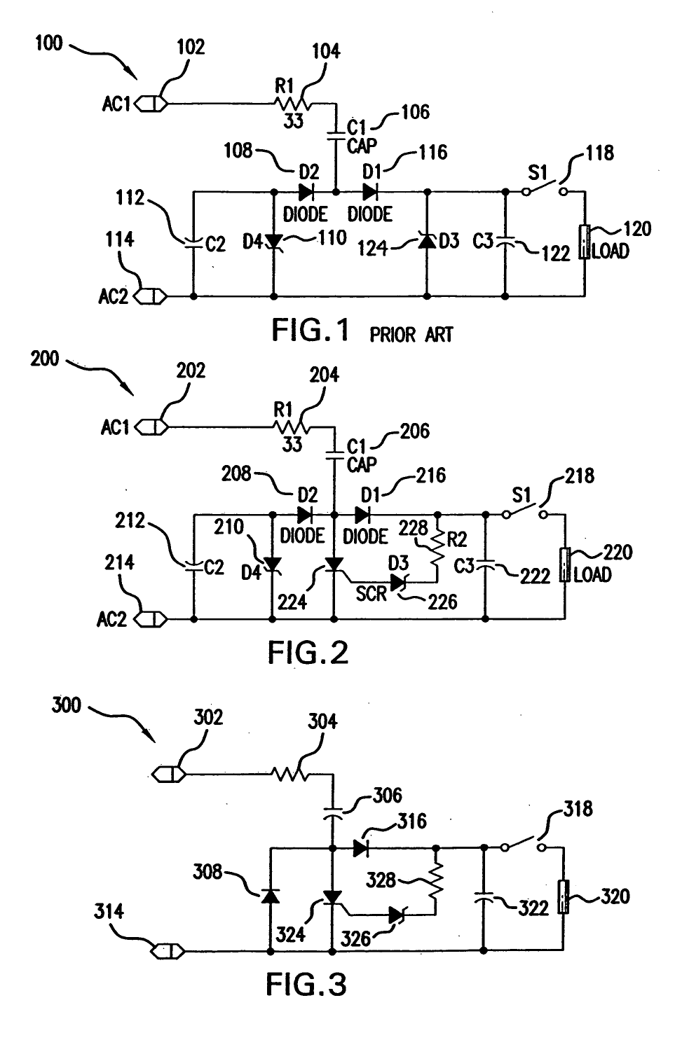

With reference now to FIG. 1 of the drawings, there is illustrated therein a power supply that is typical of prior art systems, generally designated by the reference numeral 100. The power supply 100 may include the following elements: AC source ACI 102, resistor R1 104, capacitor C1 106, diode D2 108, zener D4 110, capacitor C2 112, AC source AC2 114, diode D1 116, switch S1 118, load 120, capacitor C3 122, and zener D3 124.

FIG. 1 represents a power supply where C1 106 is the main dropping impedance for the power supply 100. C1 106 is often used to drop AC line voltage to a desired DC voltage level because the capacitor dropping impedance does not dissipate wattage except the small amount caused by the effective series resistance (ESR) of the capacitor C1 106. In one embodiment the power supply 100 may be configured as follows: AC sources AC 1 102 and AC2 114 provide current to the power supply 100. R1 104 and C1 106 are connected in series from ACI 102. The current from ACI 102 enters the power supply 100 between two diodes connected in series, D2 108 and D1 116. The switch 118 controls the current to the load 120. Capacitor C3 122 and zener D3 124 are connected in parallel relative to the load 120. As seen in FIG. 1, diode D2 108, zener diode D4 110, and capacitor C2 112 create a negative DC voltage relative to AC2 114, while diode D1 116, zener D3 124 and capacitor C3 122 create a positive DC voltage relative to AC2 114.

Even though the circuit of FIG. 1 does not dissipate wattage in C1 106, it does dissipate wattage in the DC part of the circuit through the zener D3 124. The normal current going through the load 120 when S1 118 is closed is shunted through the zener D3 124 when S1 118 is open. As a result, the wattage that was consumed by the load 120 is consumed by the zener D3 124. As mentioned above, there are two shortcomings associated with this scenario. First, the wattage dissipated by the zener D3 124 is wasted and performs no useful work. Secondly, the resulting heat on the circuit board must be dealt with, i.e., removed by the refrigeration system in order to maintain temperature.

With reference now to FIG. 2 of the drawings, there is illustrated therein a Capacitor Dropping Power Supply utilizing the principles of the present invention, generally designated by the reference numeral 200. The Capacitor Dropping Power Supply 200 may include the following elements: AC source AC1 202, resistor R1 204, capacitor C1 206, diode D2 208, zener D4 210, capacitor C2 212, AC source AC2 214, diode D1 216, switch S1 218, load 220, capacitor C3 222, SCR 224 and zener D3 226 and resistor 228. The Capacitor Dropping Power Supply 200 is configured in nearly the same manner as the power supply 100 depicted in FIG. 1, except the SCR 224 is added in parallel relative to the load 220. The SCR 224 receives its control input from zener 226. Similar to FIG. 1, C1 206 of FIG. 2 is the main dropping impedance for the power supply 200. C1 202 is used to drop the AC line voltage to the desired DC voltage. The left side of the circuit creates a negative DC voltage relative to AC2 214, while the right side creates a positive DC voltage relative to AC2 214. The invention will be described using the right side with creation of the positive DC voltage; similar arguments apply to a supply designed to provide negative voltages using the left side of FIG. 2.

The silicon control rectifier in FIG. 2 eliminates the wasted energy that occurs in the power supply described in FIG. 1. In FIG. 2 the zener current 226 is only used to trigger the SCR 224 (typically requiring about 200 micro-amps). When S1 218 is open, the load current 220 is diverted, or shunted through the SCR 224. Since the voltage across the SCR 224 when it shunts the load current is less than that of comparable zener voltage 124 of FIG. 1, the wattage or power dissipation is much smaller. As an example, a load of 0.5 watts, at 10 volts would draw 0.05 amps current. When this load is switched off, the wattage added to the zener D3 124 of FIG. 1 would be 0.05 amps times 10 volts or 0.5 watts (the entire load wattage). With the circuit of FIG. 2 the wattage added to the power supply would be 0.05 amps times the 0.7 volts of the SCR or 0.035 watts. Thus, the goal of making a power supply that dissipates almost no power is achieved by combining capacitive dropping impedance and a switching mode using the SCR.

Essentially the SCR 224 shorts out the diode 216 when power is not needed by the load 220. This is performed in the form of a voltage regulator. The zener 226 switches on whenever the voltage rises above a control level. In one embodiment of the present invention, the power supply 200 creates 5 volts on ½ of the AC wave, and on the other %2 of the AC wave the power supply 200 creates 24 volts. For example, in FIG. 2, diode D2 208 may be set up as a negative 5 volts and diode D1 216 with a positive 24 volts. In these exemplary configurations, the control level of the zener 226 may be set to 24 volts. Thus, when the zener 226 switches on at 24 volts, the SCR 224 is set to an on state, which removes the voltage across the diode 216.

SCRs conduct in only one direction. But since in the circuit provided in FIG. 2, the voltage across the SCR is AC, the SCR 224 turns off every ½ cycle. The SCR 224 turns on when the control current from the zener 226 exceeds the SCR trigger level. That is, the voltage across the power supply capacitor is checked every ½ cycle, and if the voltage is too high, the SCR 224 switches on and shunts the load. Essentially, the SCR 224 provides a shunt switcher. When the load 220 is turned on, power is provided to the load 220 because the SCR 224 turns on and off so that it supplies just enough power to supply the load 220, i.e., the control level voltage, and it shorts out any voltage above the control level. When the load is turned off, excessive power dissipation in the zener diode 226 is avoided by the same shunting process. Thus, the present invention provides a switcher across the shunt regulator so that power is diverted and changed to reactive power into the capacitor.

With reference now to FIG. 3 of the drawings, there is illustrated therein an alternative embodiment of a capacitor dropping power supply utilizing the present invention, generally designated by the reference numeral 300. As in FIG. 2 the zener current 326 in FIG. 3 is only used to trigger the SCR 324. When S1 318 is open, the load current 320 is diverted, or shunted through the SCR 324. Since the voltage across the SCR 324 when it shunts the load current is less than that of comparable zener voltage 124 of FIG. 1, the wattage or power dissipation is much smaller.

As with the embodiment provided in FIG. 2 a power supply that dissipates almost no power is provided in FIG. 3 by combining capacitive dropping impedance and a switching mode using the SCR 324. The SCR 324 acts in the form of a voltage regulator and shorts out the diode 316 when power is not needed by the load 320. The zener 326 switches on whenever the voltage rises above a control level. When the zener 326 switches on at the control level, the SCR 324 is set to an on state, which removes the voltage across the diode 316. The SCR 324 turns off every ½ cycle and turns on when the control current from the zener 326 exceeds the control level. As in FIG. 2, the voltage across the power supply capacitor in FIG. 3 is checked every ½ cycle, and if the voltage is too high, the SCR 324 switches on and shunts the load. When the load 320 is turned on, just enough power is provided to the load 320 because the SCR 324 turns on and off. When the load is turned off, excessive power dissipation in the zener diode 326 is avoided by the same shunting process.

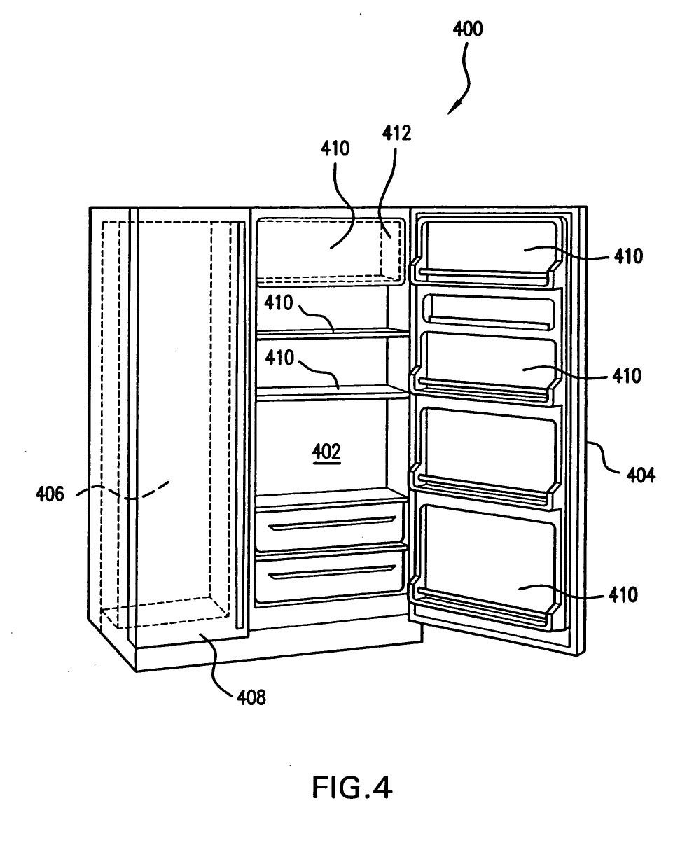

With reference now to FIG. 4 of the drawings, there is illustrated therein a refrigeration device that may use a capacitor dropping power supply utilizing the present invention, generally designated by the reference numeral 400. The refrigeration device 400 may include a refrigerator compartment 402 with a door 404 and a freezer compartment 406 with a door 408. The refrigeration device 400 may include a plurality of shelves 410 which may be mounted within both the refrigerator and freezer compartments 402 and 406, as well as on the interior surfaces of the doors 404 and 408. A temperature controlled compartment 410 may include an interior door 412 which may be accessible upon opening the refrigerator door 404.

It is to be understood that the Capacitor Dropping Power Supply 200 may be applied to either or both the positive or negative supplies. FIG. 2 depicts an embodiment where the Capacitor Dropping Power Supply is applied to the positive supply, although it can be applied to either or both. Descriptions have been provided that demonstrate the advantages that the Capacitor Dropping Power Supply brings to refrigeration appliances; however, it is to be understood that the Capacitor Dropping Power Supply may be used by any electrical device that utilizes a power supply, e.g, ranges, ovens, dryers, washers, etc.

The foregoing description of the present invention provides illustration and description, but is not intended to be exhaustive or to limit the invention to only the embodiments disclosed. Modifications and variations are possible consistent with the above teachings or may be acquired from practice of the invention. Thus, it is noted that the scope of the invention is defined by the claims and their equivalents.

1. An appliance with a capacitor dropping power supply, said capacitor dropping power supply comprising:
a first portion of said capacitor dropping power supply, said first portion creating a negative DC voltage relative to an AC source;
a second portion of said capacitor dropping power supply, said second portion creating a positive DC voltage relative to said AC source, wherein said second portion comprises:
a silicon control rectifier, said silicon control rectifier used by said capacitor dropping power supply to shunt current from a load in a manner to minimize internal power dissipation thereby increasing operational efficiency.

2. The appliance according to claim 1, wherein said silicon control rectifier turns off every ½ cycle.

3. The appliance according to claim 2, wherein said silicon control rectifier turns on whenever the DC output voltage rises above a control voltage.

4. The appliance according to claim 2, wherein said silicon control rectifier is controlled to turn on when the output DC voltage exceeds a control voltage of a zener diode.

5. The appliance according to claim 4, wherein said zener diode is connected in parallel with the load of the capacitor dropping power supply.

6. The appliance according to claim 4, wherein said silicon controlled rectifier operates as a shunt switch with minimal power dissipation in the on state.

7. The appliance according to claim 4, wherein said silicon controlled rectifier shunts input current and provides just sufficient power to supply the load.

8. The appliance according to claim 4, wherein said silicon controlled rectifier shorts out voltages above said control voltage.

9. The appliance according to claim 4, wherein said silicon controlled rectifier creates a power savings when power is not being supplied to the load.

10. The appliance according to claim 1, wherein said appliance is a refrigeration device.

11. The appliance according to claim 10, wherein said capacitor dropping power supply avoids the creation and removal of heat caused by internal dissipation in the refrigeration device.

12. A capacitor dropping power supply comprising:
a first portion of said capacitor dropping power supply, said first portion creating a positive DC voltage relative to an AC source;
a second portion of said capacitor dropping power supply, said second portion creating a negative DC voltage relative to said AC source, wherein said second portion comprises:
a silicon control rectifier, said silicon control rectifier used by said capacitor dropping power supply to shunt current from a load in a manner to minimize internal power dissipation thereby increasing operational efficiency.

13. A silicon control rectifier in a capacitor dropping power supply, said silicon control rectifier connected in parallel to a load, wherein said silicon control rectifier shunts current when said load is turned off, said current normally used to supply power when the load is on, in a manner to minimize internal power dissipation thereby increasing operational efficiency of said capacitor dropping supply.

14. The silicon control rectifier according to claim 13 wherein said silicon control rectifier receives a control input from a zener diode connected in parallel with said load, said zener diode sending said control input when an output DC voltage exceeds a control voltage of said zener diode.

15. The silicon control rectifier according to claim 14, wherein said silicon control rectifier turns off every ½ cycle.

16. The silicon control rectifier according to claim 14, wherein said silicon control rectifier turns on whenever the DC output voltage rises above the control voltage of said zener diode.

17. The silicon control rectifier according to claim 14, wherein said silicon controlled rectifier operates as a shunt switch with minimal power dissipation in the on state.

18. The silicon control rectifier according to claim 14, wherein said silicon controlled rectifier provides just sufficient power to supply the load.

19. The silicon control rectifier according to claim 14, wherein said silicon controlled rectifier shorts out voltages above said control voltage.

20. The silicon control rectifier according to claim 14, wherein said capacitor dropping power supply is internal in a refrigeration device.
